(19) United States
(12) Patent Application Publication
(10) Pub. No.: US 2017/0201881 A1
(43) Pub. Date: Jul. 13, 2017

(54) USE OF SCANNABLE CODES ASSOCIATED WITH AN ACCESS DEVICE

(71) Applicant: THOMSON LICENSING, Issy Les Moulineaux (FR)

(72) Inventors: Martin VINCENT DAVEY, Indianapolis, IN (US); Robert Nathan SMITH, Carmel, IN (US)

(21) Appl. No.: 15/313,759

(22) PCT Filed: Jun. 5, 2015
(86) PCT No.: PCT/US2015/034419

§ 371 Date: Nov. 23, 2016

Related U.S. Application Data
(60) Provisional application No. 62/013,757, filed on Jun. 18, 2014.

(51) Int. Cl. H04W 12/06; G06K 7/14; G06K 19/06; H04W 12/08; H04L 29/06

(52) U.S. Cl. CPC H04W 12/06; H04W 12/08; H04L 63/083; G06K 19/06037; G06K 7/1417

(57) ABSTRACT

A method and apparatus for using a scannable code is described including scanning the scannable code, launching a browser, browsing to an IP address to access a web configuration page of an access device, logging into the web configuration page of the access device with default login credentials, accessing a default wireless network via a default network identification and default wireless network password and setting up the default wireless network using default wireless network access information of the access device.

### FIELD OF THE INVENTION

The present invention relates generally to scannable codes, their use and how scannable codes are associated with a device.

### BACKGROUND OF THE INVENTION

Gaining access to a wireless network is done by entering or selecting a known network identification (such as an SSID) and entering a password. For public networks, the password is usually not needed. On a typical wireless gateway product that allows guests to access an extension of the service provider's network via a wireless network hotspot, the user would have to manually find and select the specified wireless network on their device and then enter specific credentials to log in/authenticate, authorize and account (AAA) for wireless network usage. Usually, the configuration web page of the gateway product is accessed via a web browser by knowing the internet protocol (IP) address of the gateway, the username and password. The network name and network identification (e.g., SSID) are usually found on a sticker on the back side of the router or it can be found by logging into the configuration web page of the router. As used herein the term gateway product or device includes but is not limited to a gateway, modem, router, bridge and/or brouter. Any of the above names (terms) are used interchangeably herein.

### SUMMARY OF THE INVENTION

The proposed apparatus provides a mechanism to connect to a wireless network by scanning a code; to gain access to a wireless modem, router, or gateway's wireless network hotspot feature by scanning the code on the outside of the unit; to connect to a modem, a router or a gateway's web page or configuration page or login page by scanning the code on the outside of the unit. The scannable code may also be embedded into the mechanical structure of a modem, router, bridge, brouter or gateway device. A QR code is an example of a scannable code.

On a typical wireless gateway product that allows guests to access an extension of the service provider's network via a wireless network hotspot, the user would have to manually find and select the specified wireless network on their device and then enter specific credentials to log in/authenticate, authorize and account (AAA) for wireless network usage. Usually, the configuration web page of the gateway device is accessed via a web browser by knowing the internet protocol (IP) address of the gateway, the username and password.

The proposed apparatus allows a wireless network provider to supply wireless network access credentials by using a scannable code. The scannable code could be generated from a local kiosk or terminal in the vicinity of the wireless network. The wireless network provider will charge a fee or payment. The user is presented a scannable code via the kiosk, and the user scans the code with their handheld device. The wireless network access device will be configured for the wireless network. The configuration may be automatic.

The proposed apparatus replaces the need to manually locate and select the wireless network and enter the specific credentials for authentication, authorization and accounting. The user will scan the code located on the unit or embedded into the mechanical structure of the device and the user's device will then select the wireless network hotspot and be granted access to the service provider's network.

The proposed apparatus will take the place of knowing the internet protocol (IP) address of the login page to access the configuration web pages. The user will scan the code on a sticker located on the unit or embedded into the mechanical structure of the device. The user will then be taken to the login page of the device (but the user may not be logged in/authenticated). The proposed apparatus may also take the place of knowing this information and the user may scan the code on a sticker located on the unit or embedded into the mechanical structure of the device. The user will then be automatically logged into the web page with proper credentials by scanning the code on the sticker or embedded into the mechanical structure of the device.

On a typical gateway product, various device specific information (e.g., IP address, default login name and password, MAC address, serial #, default wireless network identification (e.g., SSID), default wireless network password, default wireless network access information (e.g., WPS PIN), etc.) is presented to the user via a sticker somewhere on the device or the information can be found by logging into the configuration page of the router. This information aids the user in the configuration and use of the device.

The proposed apparatus replaces the sticker with a scannable code and allows the information to be more easily accessed and used by embedding a scannable code into the mechanical structure of the device. The scannable code can then be scanned by a user with a handheld device for easy access to and use of the information. Various applications could automatically translate the scannable code information into actions to configure, provision, or setup the device or its features. Scannable code stickers may become useless through overuse or intentional mutilation. Embedded a scannable code on the mechanical structure may provide a longer life cycle for the scannable code.

The proposed apparatus will allow the administrator of the router for a public network to select an network identification (such as SSID), password, define the duration of access and create a scannable code that allows the user of a handheld device to scan the code to access the wireless network. Network access may be automatic.

A method and apparatus for using a scannable code is described including scanning a scannable code, launching a browser, browsing to an IP address of an access to access a web configuration page for the access device, logging into the web configuration page of the access device with default login credentials, accessing a default wireless network via a default network identification and default wireless network password and setting up a wireless network using default network access information of the access device.

### BRIEF DESCRIPTION OF THE DRAWINGS

The present invention is best understood from the following detailed description when read in conjunction with the accompanying drawings. The drawings include the following figures briefly described below:

FIG. 1 is an exemplary scannable code.

FIG. 2 is an exemplary scannable code embedded into the mechanical structure of a gateway product.

FIG. 3 is a flowchart of an exemplary method of the operation of a scannable code such as may be on a sticker on an access device or embedded in the mechanical structure of an access device.

### DETAILED DESCRIPTION OF THE PREFERRED EMBODIMENTS

As mobile phone and handheld devices proliferate and most of these devices having a camera, scanning a scannable code will become common place. Most all modern handheld devices have capabilities to join wireless networks. Many public places offer free wireless network access but for private locations or private businesses, only a private wireless network is available. Therefore, the wireless network access is not free, but available.

A kiosk in the area of the wireless network could be used. The user would insert their credit card into the kiosk and a scannable code would be generated so the user could scan the scannable code and the device would be configured for the wireless network. The user's access could be time limited depending on the level of accessed purchased. Also, a business could offer pre-paid cards with wireless network access minutes for a business location. Wireless network access minutes could be added to the card using a credit card. The scannable code on the card configures the wireless network access device to gain access to the wireless network. A wireless network access device (modem, gateway, router, bridge, router etc.) with a scannable code would be particularly useful for business travelers at hotels and motels. Each guest could be granted a certain amount of network access time upon check-in and any additional time could be charged to their room. The scannable code could be a sticker on the access device or embedded in the mechanical structure of the access device. In a hotel environment, it would be better to have the scannable code built into the mechanical structure so that a guest cannot accidentally or otherwise remove the sticker.

For typical home hotspot access, users must know which wireless network to select and connect to the wireless network, and then enter specific credentials provided previously from the service provider. With a scannable code on the gateway device, the user can scan the scannable code and have the device automatically locate, select and be authenticated, authorized and accountable (AAA) to/for the wireless network access hotspot and its use, gaining access to the service provider's network. Authentication, authorization and accounting may be automatic. The scannable code would replace any device specific information. This would be particularly useful when you are a guest in someone's home and need to access a network. Neither the homeowner nor the guest would have to know the device specific information but only scan the scannable code which may be on a sticker on the device or elsewhere or embedded into the mechanical structure of the device. Embedded in the scannable code is the wireless network hotspot name/identification (e.g., SSID) and the respective login credentials required to access the service provider's network via the hotspot.

In another home wireless network example, some home wireless networks have routers that have dual bands. One band may be faster but offer less distance. A second band may be slightly slower but offer greater distance. Therefore, a plurality of home wireless network access options are possible. Several scannable codes may be embedded into the structure of the access device (such as a router). The scannable code most visible (on the top of the device) may be for accessing a guest network on one of the bands. Second and third codes could be embedded into the device for accessing both of the bands with full privileges. The second and third scannable codes may be less conspicuously placed on the access device, for example on the underside of the access device. A dual band router manufacturer may also provide stickers for access to the guest network that can be affixed to other conveniently placed appliances in the home for guests to scan. For example, if the home office is located upstairs near bedrooms and the home owner does not wish his/her guests to access the home office or private areas of the home, the access device manufacturer may offer stickers that can be affixed to a set top box, a refrigerator, TV or the like. The guest may be directed to the scannable code on the appliance in the public areas of the home to scan the scannable code for guest access to the home wireless network.

Most all modems or routers have various device specific information (e.g., IP address, default login name and password, MAC address, serial number, default wireless network identification (e.g., SSID), default wireless network password, default wireless network access information (e.g., WPS-PIN), etc.) presented via a sticker on the device for use by the user. With a scannable code embedded into the structure of the device, the user can scan the scannable code and perform various actions that require this information without having to read or translate the information from a sticker. The performance of the various actions may be automatic.

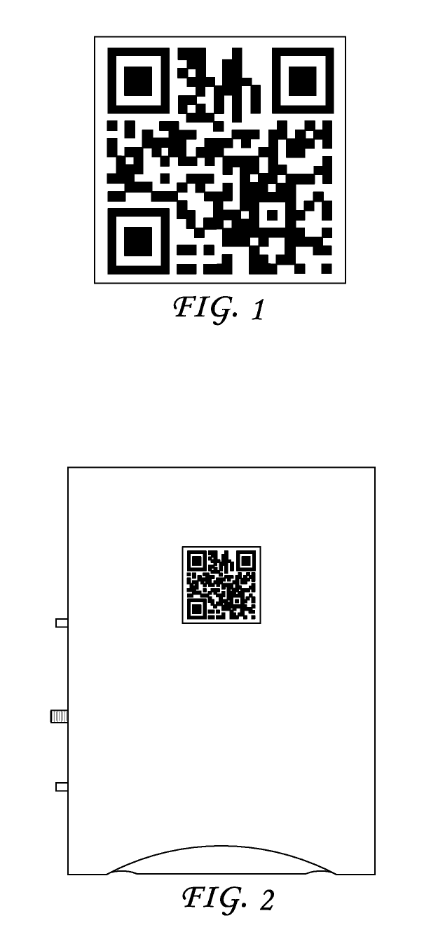

A scannable code such as shown in FIG. 1 could be directly incorporated into the mechanical structure of the product (e.g., engraved, or ventilation holes/structure designed in the pattern of a scannable code) such as shown in FIG. 2.

When the user scans the scannable code, the information could then be used to perform various tasks that the user would have had to do by manually reading and inputting the information. Some examples include:
Launching a browser and browsing to the device's IP address to access the Web configuration pages
logging into the access device's configuration web pages with the default login credentials
Accessing the default Wi-Fi network via the default network identification and default wireless network password
Setting up a wireless network utilizing the default wireless network access information (such as WiFi Protected Set-up (WPS) Personal Identification Number (PIN) information) of the device

Most all modems or routers or other access device in the home have a web based configuration page. The web configuration page requires knowledge of the gateway IP address (e.g., 192.168.1.1), a username and password before logging in. The configuration page may be at a specific gateway IP address (e.g., 192.168.1.1). With a sticker with a scannable code on the gateway device or a scannable code embedded into the mechanical structure of the device, the user can scan the scannable code and have the browser automatically launch on the handheld device.

When the user scans the scannable code, it will launch a browser. Embedded in the scannable code is the IP address of the gateway along with credentials to login into the gateway or web page. Another option, instead of using the IP address in the scannable code, a URL could be used, e.g., mygateway.lan, and the gateway will resolve the DNS name locally and launch the browser with the appropriate IP address.

A corporate guest may wish to use the corporate wireless network so the administrator of the wireless network goes to the sticker on the modem and finds the network identification and password or the administrator of the modem logs in to the configuration web page and locates the network identification and password for their guests. Another way to do this is the administrator logs into the configuration page and a display is created that has options for which network identification to use and the password. So, if the administrator is ok with the guest using the default network identification, the web page creates a scannable code and the wireless network access device scans the scannable code and the wireless network access device is logged on. The logging on may be automatic. The guest is not aware of the wireless network password. If the administrator does not want his/her guest on the default wireless network, he/she can activate another network identification and password. The web page creates a scannable code and the wireless network access device scans the scannable code and the wireless network access device is logged on to a guest network. The logging on may be automatic. The guest is not aware of the wireless network password. If the administrator does not want his/her guest on the wireless network forever, he/she can activate the network identification and password and set the duration of activation, so the guest can only be allowed to use the network identification for a certain amount of time. For example, the administrator can activate the network identification for an hour, and after that hour, the guest access will be de-activated. The web page creates a scannable code and the wireless network access device scans the scannable code and the wireless network access device is logged on. The logging on may be automatic. The guest is not aware of the Wi-Fi password.

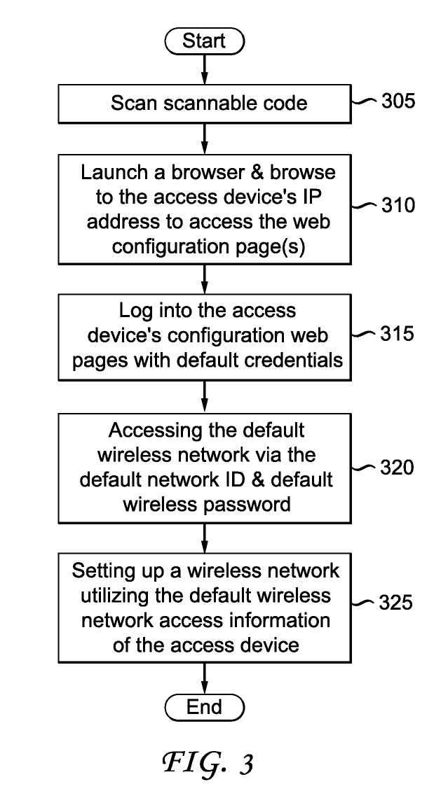

FIG. 3 is a flowchart of an exemplary method of the operation of a scannable code such as may be on a sticker on an access device or embedded in the mechanical structure of an access device. At 305 a user scans a scannable code on an access device. At 310 the scannable code results in launching a browser and browsing to the access device's IP address to access the web configuration page(s) for the access device. At 315 the device which wants to access the wireless network is logged into the access device's configuration web page(s) with the default login credentials. At 320 the device which wants to access the wireless network accesses the default wireless network via the default network identification and default wireless network password. At 325 the wireless network is set up using the default wireless network access information (for example, WPS PIN information) of the access device. The launching and logging in may be automatic.

It is to be understood that the present invention may be implemented in various forms of hardware, software, firmware, special purpose processors, or a combination thereof. Special purpose processors may include application specific integrated circuits (ASICs), reduced instruction set computers (RISCs) and/or field programmable gate arrays (FPGAs). Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

1-21. (canceled)

22. A method, said method comprising:
scanning a scannable code, said scannable code including network access credentials for a service provider's network;
accessing a wireless network via a network identification and wireless network password, said network identification and said network password included in said scannable code;
setting up said wireless network using wireless network access information of the access device; and
accessing said service provider's network.

23. The method according to claim 22, wherein said scannable code is embedded in a mechanical structure of said access device.

24. The method according to claim 22, wherein said scannable code is a sticker on said access device.

25. The method according to claim 22, wherein said scannable code is a sticker on a convenient appliance in a public area.

26. The method according to claim 22, wherein said scannable code is a QR code.

27. The method according to claim 22, wherein said network access information is a Wi-Fi Protected Set-up (WPS) Personal Identification Number (PIN).

28. The method according to claim 22, wherein the browser is launched automatically.

29. The method according to claim 22, wherein said logging into the web configuration page of the access device is automatic.

30. The method according to claim 22, wherein said network identification is an SSID.

31. The method according to claim 22, further comprising:
launching a browser;
browsing to an IP address of an access device to access a web configuration page for the access device; and
logging into the web configuration page of the access device with login credentials.

32. A scanning apparatus, comprising:
a camera, said camera scanning a scannable code, said scannable code including network access credentials for a service provider's network;
wherein said scannable code the method according to any of said preceding claim.

33. A computer program product stored in non-transitory computer-readable storage for using a scannable code to access a wireless network, comprising computer-executable instructions for:
accessing a wireless network via a network identification and wireless network password said network identification and said network password included in said scannable code;
setting up said wireless network access using wireless network access information of the access device; and
accessing said service provider's network.

34. The computer-readable program product, wherein said computer-executable instructions further:
launching a browser;
browsing to an IP address of an access device to access a web configuration page for the access device; and
logging into the web configuration page of the access device with login credentials.
